(19) United States
(12) Patent Application Publication
(10) Pub. No.: US 2023/0103617 A1
(43) Pub. Date: Apr. 6, 2023

(54) METHOD AND DEVICE FOR PROVIDING TRAINING CONTENT USING AI TUTOR

(71) Applicant: RIIID INC., Seoul (KR)

(72) Inventors: Young Duck CHOI, Seoul (KR); Yun Ah SUN, Seoul (KR); Min Sung NOH, Seoul (KR); Young Jik YOON, Seoul (KR); Yoon Ho NA, Seoul (KR); Kyu Jin KIM, Seoul (KR); Jae We HEO, Seoul (KR); Jin Eon BAEK, Seoul (KR); Dong Min SHIN, Seoul (KR)

(21) Appl. No.: 17/427,595

(22) PCT Filed: May 24, 2021
(86) PCT No.: PCT/KR2021/006428

§ 371 Date: Jul. 30, 2021

(51) Int. Cl. G09B 7/02; G09B 7/077

(52) U.S. Cl. CPC G09B 7/02; G09B 7/077

(57) ABSTRACT

The present disclosure relates to a method and device for providing training content. A method may comprise displaying a question card including a first area and a second area; determining a recommended question using an artificial intelligence (AI) model trained on the basis of training data of a user; displaying, on the first area of a screen of a learner terminal, a plurality of prediction values for information obtained by analyzing a correlation between the training ability of the user and the recommended question using the AI model, together with the recommended question; displaying summary information about the recommended question on the second area of the screen of the learner terminal; and displaying a question object of the recommended question on the screen of the learner terminal when the user decides to solve the recommended question on the basis of the plurality of prediction values and the summary information.

### TECHNICAL FIELD

The present disclosure relates to a method and device for providing training content. More specifically, the present disclosure relates to a method and device for providing training content, which analyzes a question-solving result of a user through artificial intelligence (AI) to provide a recommended question and a question card and allows the user to select a recommended question desired to be solved according to the user's taste, thereby stimulating learner's motivation and providing effective training content.

### BACKGROUND ART

Recently, as the use of the Internet and electronic devices has been actively increased in most fields, the educational environment is also changing rapidly. In particular, with the development of various educational media, learners can choose and use a wider range of training methods. Among them, the education service through the Internet has become a major teaching and training method because of the advantage of overcoming time and space constraints and enabling low-cost education.

In response to this trend, customized education services, which were not possible in offline education due to limited human and material resources, are also diversifying. For example, by providing class-specific training according to the learner's individuality and ability, educational content is provided according to the individual competency of the learner, beyond the conventional uniform teaching methods.

Because each learner's individuality and abilities are different, it is necessary to properly process this information and provide the processed information to users. However, the existing training content simply notifies only the probability of a correct answer or simply provides an expected score, so there is a problem in that it is difficult for the user to effectively link the analyzed information to training.

### DISCLOSURE

### Technical Problem

Therefore, the present disclosure has been made in view of the above-mentioned problems, and the present disclosure provides a method and device for providing training content, which may analyze training ability of a user related to a recommended question through various artificial intelligence (AI) models to provide the analyzed information in the form of a question card, so that the user can intuitively realize information about the recommended question and the necessity of solving the recommended question, and the user can select and solve a question he or she wants through a swipe function.

### Technical Solution

The present disclosure relates to a method for providing training content through a user interface that can have higher training efficiency. In accordance with an aspect of the present disclosure, a method for providing training content through a question card including a first area and a second area, the method includes: determining a recommended question using an artificial intelligence (AI) model trained on the basis of training data of a user; displaying, on the first area of a screen of a learner terminal, a plurality of prediction values for information obtained by analyzing a correlation between the training ability of the user and the recommended question using the AI model, together with the recommended question; displaying summary information about the recommended question on the second area of the screen of the learner terminal; and displaying a question object of the recommended question on the screen of the learner terminal when the user decides to solve the recommended question on the basis of the plurality of prediction values and the summary information.

In accordance with another aspect of the present disclosure, a device for providing training content for providing a user interface that can have higher training efficiency, the device may include: a storage unit configured to store training content and training data of users; a UI generation unit configured to generate a user interface for displaying a plurality of prediction values for information obtained by analyzing a recommended question determined using an AI model trained on the basis of the training data and a correlation between user's training ability and the recommended question using the AI model; and a communication unit configured to transmit the training content and the plurality of prediction values displayed according to the user interface to a learner terminal, wherein the plurality of prediction values together with the recommended question are displayed on a first area of a screen of the learner terminal, summary information about the recommended question is displayed on a second area, and a question object of the recommended question is displayed on the screen of the learner terminal when the user decides to solve the recommended question on the basis of the plurality of prediction values and the summary information.

### Advantageous Effects

According to the present disclosure, by analyzing training ability of a user related to a recommended question through various AI models and providing the analyzed information in the form of a question card, it is possible for the user to intuitively realize information about the recommended question and the necessity of solving the recommended question.

According to the present disclosure, it is possible to enable the selection of a recommended question according to user's taste through a swipe function of a question card, and enable one-to-one bilateral interaction between the user and an AI tutor, beyond the existing compulsory relationship in which the AI tutor unilaterally provides a recommended question.

According to the present disclosure, it is possible to allow a user to request for another question by skipping a recommended question that the user does not want to solve, thereby preventing a decrease in training efficiency caused by dropout from a training program.

### DESCRIPTION OF DRAWINGS

FIG. 1 is a diagram illustrating a device for providing training content and an operating environment thereof according to an embodiment of the present disclosure.

FIG. 2 is a diagram illustrating a configuration of an intro screen and a radar chart according to an embodiment of the present disclosure.

FIG. 3 is a diagram illustrating in detail an AI prediction value according to an embodiment of the present disclosure.

FIG. 4 is a diagram illustrating the overall operation of an AI tutor according to an embodiment of the present disclosure.

FIG. 5 is a diagram illustrating in detail a question card according to an embodiment of the present disclosure.

FIG. 6 is a diagram illustrating a gradation display window of a question card according to an embodiment of the present disclosure.

FIG. 7 is a diagram illustrating a swipe guide message according to an embodiment of the present disclosure.

FIG. 8 is a diagram illustrating a swipe operation according to an embodiment of the present disclosure.

FIG. 9 is a diagram illustrating a customization configuration according to an embodiment of the present disclosure.

FIG. 10 is a diagram illustrating a radar chart in the case where there is one item having the highest value according to an embodiment of the present disclosure.

FIG. 11 is a diagram illustrating a radar chart when there are two or more items having the highest value according to an embodiment of the present disclosure.

FIG. 12 is a diagram illustrating a radar chart in the case where values of all items are the same according to an embodiment of the present disclosure.

### MODE FOR INVENTION

The above-described objectives, features, and advantages will be described below in detail with reference to the accompanying drawings, and accordingly, those skilled in the art to which the present disclosure pertains will be able to easily implement the technical idea of the present disclosure. In describing the present disclosure, if it is determined that a detailed description of a known technology related to the present disclosure may unnecessarily obscure the gist of the present disclosure, the detailed description will be omitted.

Hereinafter, embodiments according to the present disclosure will be described in detail with reference to the accompanying drawings. In the drawings, the same reference numerals are used to refer to the same or similar elements, and all combinations described in the specification and claims may be combined in any manner. Unless otherwise specified, it is to be understood that a singular expression may include one or more, and also includes a plural expression.

In this specification, the term “question-solving mode” means a state in which a learner can listen to or read text and questions and select choices, and the “scoring mode” means a state in which a learner provides the result and explanation of the choice selected by the learner.

Also, in the present specification, a “text object” is an independent object representing text, and may be classified into a character text, a photo text, and a voice text according to characteristics thereof. The “character text” refers to text given to solve a question, and the “photo text” refers to a photo given to solve a question, and the “voice text” refers to a voice given to solve a question. In the case of a listening question in which both the question and the choices consist of voice, it can be understood that the “voice text” may include a voice related to the choice in terms of content.

A “question object” is a concept corresponding to one question as an object that is composed of a question and/or choices and can receive a user's choice selection input. Throughout the specification of the present disclosure, a “question” means content composed of a text and choices, and the “question” may be understood as a concept including both a “single question” in which one question is related to one text and a “combination question” or a “group question” in which multiple questions are related to one text.

“Training content” is a concept that comprehensively includes all content used for training, may be content organized for each subject (noun, verb, adverb, preposition, grammar, listening, writing, reading, sentence format, etc.) and for each question type (Part 1, Part 2, . . . of TOEIC), and may be classified according to the training method (question solving, video lecture, text lecture, etc.). That is, the training content is a concept that encompasses question solving content, lecture content, and the like. In this specification, as an example, an embodiment in which “question solving content” composed of one or more questions is provided has been described, and in the description of another embodiment, an example in which the training content is divided into text object and question object has been described.

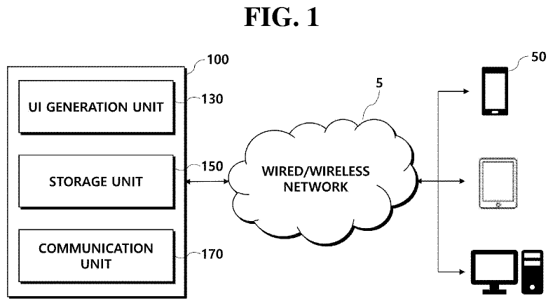

FIG. 1 is a diagram illustrating a device for providing training content and an operating environment thereof according to an embodiment of the present disclosure.

Referring to FIG. 1, a device 100 for providing training content according to the present disclosure may be a server including a UI generation unit 130, a storage unit 150, and a communication unit 170, and may further include a learner management unit 190. The device 100 for providing training content may provide questions to a learner terminal 50 through a wired/wireless network 5, and the learner terminal 50 may confirm questions through a web browser or an application program installed in the terminal 50.

The UI generation unit 130 may generate a user interface that can effectively provide question solving and training content stored in the storage unit 150. The question solving and the training content may include questions for foreign language tests such as TOEIL, TOEFL, IELTS, JLPT, HSK, etc., and may include worksheet questions for elementary, middle, and high school students for each subject. In this specification, as a main example, an embodiment of the case where the TOEIC test questions are provided through a web page will be described, but the present disclosure is not limited to the content and type of the question.

The UI generation unit 130 may configure the following web page to provide questions through a web page.

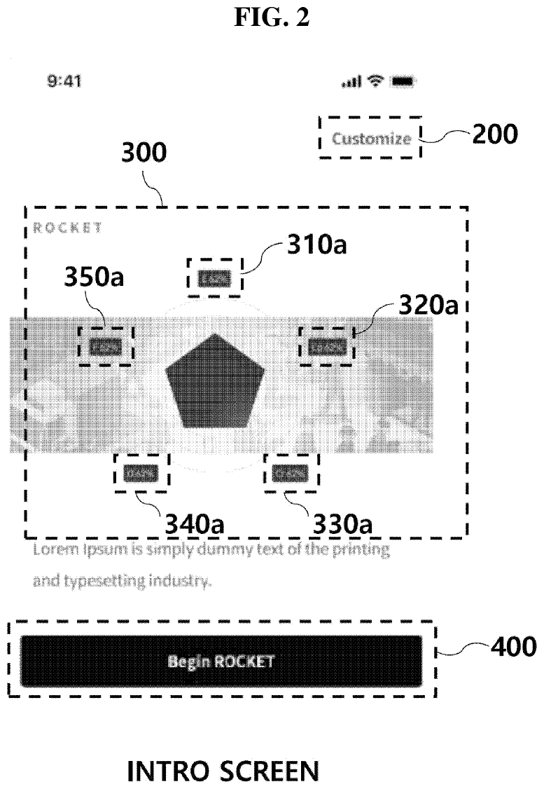

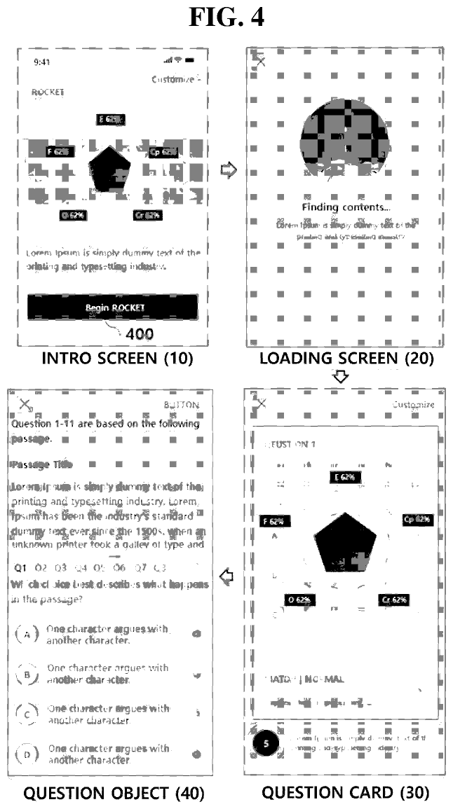

The UI generation unit 130 may display an intro screen as shown in FIG. 2 (see reference numeral 10 of FIG. 4). The intro screen may be a screen first displayed on a screen when a user executes a training program.

The intro screen may include a customization configuration object 200, a radar chart 300, and a training program start object 400.

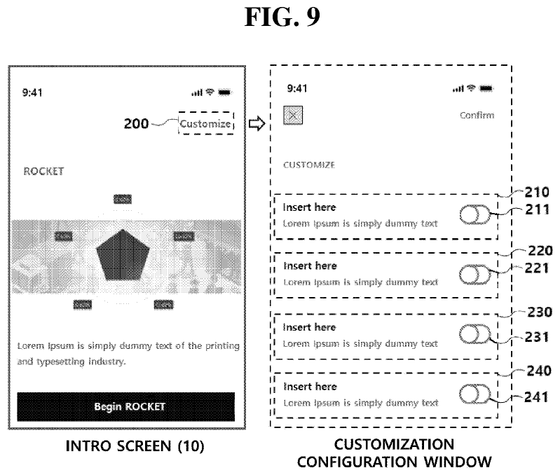

When the customization configuration object 200 is clicked, a customization configuration window in which the user can select a criterion for recommending a question may be activated as shown in FIG. 9 to be described later. The customization configuration may be a function capable of configuring various user-customized question recommendation conditions, including receiving recommendations only for questions for a specific subject, receiving recommendations only for questions with specific tags, and receiving recommendations only for questions with specific difficulty.

The radar chart 300 may display what information (E, Cp, Cr, O, F) indicated by each prediction value before providing the AI prediction value for the individual user. Although the radar chart object 300 of FIG. 2 was illustrated as displaying five AI prediction values 310a, 320a, 330a, 340a, and 350a, but the radar chart object 300 may include more or fewer prediction values depending on the embodiment, and information indicated by each prediction value may also vary depending on the embodiment.

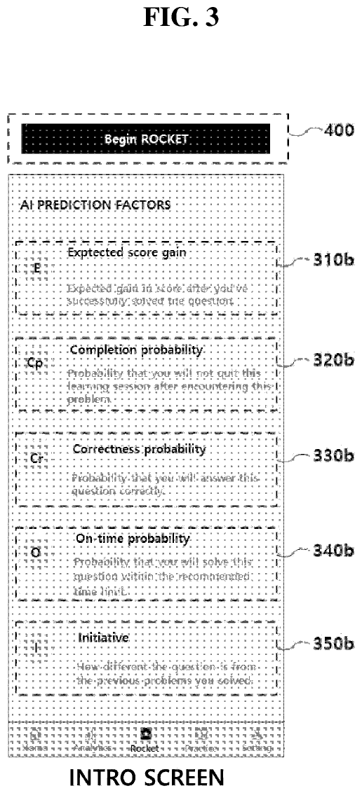

The user can check what each prediction value means through the screen of FIG. 3 connected from FIG. 2. The user can bring up FIG. 3 by dragging the screen down from the intro screen of FIG. 2, and through this, before starting training in earnest, the user can be guided in advance on how to understand a question card of a recommended question provided by an AI tutor.

However, if the screen size is sufficient to display both the screens of FIGS. 2 and 3, the user can simultaneously check the corresponding information on the same screens of FIGS. 2 and 3 without a separate drag operation.

When the training program start object 400 is clicked, a recommended question may be provided together with the radar chart 300 and real training can be started.

FIG. 3 is a diagram illustrating in detail an AI prediction value according to an embodiment of the present disclosure.

Referring to FIG. 3, a user may check what each of the above-mentioned prediction values means. Specifically, a predicted acquisition score 310b may be a test score predicted through AI after solving a recommended question. When the user gets the recommended question correct, the predicted score may be adjusted upward when the next recommended question and question card are provided. Conversely, when the user gets the recommended question incorrect, the predicted score may be adjusted downward when the next recommended question and question card are provided.

By checking the predicted question score and comparing it with his or her target score whenever solving one question, the user may be motivated to get one more question correct so that the predicted question score can reach the target score.

A solving completion probability 320b may be a probability that the user completes the solution after encountering a corresponding question. That is, the solving completion probability 320b may be the probability of solving the question until the end without terminating the training program even after starting to solve the question. The user may infer the difficulty of the question by looking at the solving completion probability 320b, and may have a desire to complete the question until the end by challenging the solving completion probability 320b suggested by the AI tutor.

The user may cultivate their training abilities through a process of constantly encountering and pondering questions that are more difficult than their own training abilities. The solving completion probability 320b may reduce the user's desire to terminate the training program when encountering such a difficult question, and has the effect of inducing the user to steadily solve more difficult questions.

A correct answer probability 330b may be a probability that the user got a given question correct. Various methods described below may be used for calculating the correct answer probability 330b.

For example, even if an AI model of a recurrent artificial neural network (RNN) structure is used, 1) a method using a bidirectional LTSTM structure in which a question solved by the user and the answer of the question are embedded in a forward sequence and a backward sequence and 2) a method of assigning a weight to a question that has a high influence on predicting the correct answer probability and calculating the correct answer probability on the basis of the assigned weight may be used, which is not simply based on the similarity of the question vector.

In addition, even if a transformer-structured AI model is used, 1) a method of inputting question information as training data for training an AI model to an encoder and inputting solving information as training data for training an AI model to a decoder and 2) a method of performing upper triangular masking in both the encoder and the decoder to prevent the correct answer probability from being predicted from a question that has not yet been solved may be used.

The user may check the correct answer probability 330b of the recommended question, may determine that a question with a high correct answer probability is unnecessary to be solved, and move on to the next question. Conversely, a question with a significantly low correct answer probability may be determined to be too early to be solved in one's training level and move on to the next question. Furthermore, when the correct answer probability 330b is low, the motivation to be sure to get the correct answer may be inspired, which may serve as a stimulant to focus more on training.

An on-time probability 340b may be a probability of solving a given question within a predetermined time. The user may check the on-time probability 340b and may try to solve the recommended question in spare time, and may have a gradually improved question-solving speed through an effort to solve the question within a given time.

A difference 350b may be a numerical value quantitatively indicating a difference between a question previously solved by the user and a newly given question. When the user repeatedly solves only similar types of questions, the user can easily get bored and quit training. The AI tutor according to an embodiment of the present disclosure may provide the difference 350b that expresses the difference with the previously solved questions as a quantitative indicator, so that the user's desire to solve a new type of question instead of the repeatedly solved question can be reflected.

In addition to the correct answer probability 350b, each prediction value may be predicted according to various AI models. AI can be defined as a system for training an AI model based on empirical data, performing prediction, and improving their own performance, and a set of algorithms for the system.

The model used by the training program according to an embodiment of the present disclosure may use any one of deep neural networks (DNN), convolutional deep neural network (CNN), recurrent neural networks (RNN), and deep belief networks (DBN) among these machine learning models.

In addition, the model used by the training program according to an embodiment of the present disclosure may use any one AI model of the recurrent artificial neural network (RNN) that stores the state inside the neural network to model time-varying dynamic characteristics since the connections between units have a characteristic having a cyclic structure, long-short-term memory (LSTM), which is a type of recurrent artificial neural network, that is implemented to enable both long-term and short-term memory using a gate, a transformer with a structure that separates the encoder and the decoder and assigns weights through self-attention, and BERT.

Each artificial neural network model may synthesize the user's question-solving results to give weight to questions that have a great influence on predicting the correct answer probability, for example, questions of types which are frequently wrong. The operation in which the weight is assigned may be referred to as a training process of the artificial neural network.

The artificial neural network that has been trained may calculate an AI prediction value based on the determined weight and provide a recommended question that is predicted to have higher training efficiency in consideration of the user's training ability.

Regardless of the AI model, a configuration of input data used for training and inference of the AI model may be configured in a format optimized for training content. For example, question information input to the AI model may include one or more of question identification information, which is a unique ID given to each question, question category information informing what type of question the corresponding question is, and location information indicating where the corresponding question is located within the overall question sequence. Answer information may be configured to include one or more of location information and answer accuracy information indicating whether the user's answer is correct or incorrect, thereby implementing the AI model having higher accuracy.

A data format of the question information and the answer information may be particularly effective in calculating a predicted acquisition score or a correct answer probability.

According to some embodiments, the question information may include one or more of the question identification information, the question category information, start time information, which is when the user first encountered the corresponding question, input sequence location information about where the question or answer is located within the entire question sequence or answer sequence, and in one session, and session location information regarding where the question or answer is located. The answer information may include one or more of start time information, input sequence location information, session location information, answer accuracy information, required time information, time-based solving information, and dropout rate information, which is a probability that the user drops out of the training program during training.

The data format of the question information and the answer information may be particularly effective in calculating a solving completion probability.

In an embodiment of the present disclosure, whenever a recommended question is provided, a question card may be provided to the user together with the recommended question. The user may check the user's AI prediction values related to the recommended question and information about the recommended question itself through the question card, and may determine whether to solve the corresponding question according to his or her taste.

Whenever the user solves a question, the AI prediction value may be updated by reflecting the user's solving result. The user's question-solving results may be stored in real time and reflected in the AI model so that the weights can be adjusted. The adjusted weights can be used to calculate the AI prediction values when an arbitrary question that has not been solved by user is input.

This process may be repeated every time the user completes solving the question, and changed user's training ability may be reflected in the AI model in real time. Since each learner has different individualities and abilities, it is necessary to provide training content that is predicted to have the highest training efficiency. However, since the existing training content simply informs only the correct answer probability or provides only the expected score, there is a problem in that it is difficult for the user to effectively link the analyzed information to training.

According to a method and device for providing training content according to an embodiment of the present disclosure, the user can pre-estimate a correlation between the recommended question and his or her training abilities through the question card, and select the recommended question according to the user's taste, thereby enabling one-to-one bilateral interaction between the user and the AI tutor, beyond the existing compulsory relationship in which the AI tutor unilaterally provides the recommended question.

Referring again to FIG. 2, the user may be provided with the recommended question and the question card for the recommended question by clicking the training program start object 400. When the training program start object 400 is clicked, the question card may be activated after being loaded for a predetermined time.

The above-described series of processes may be understood through the description of FIG. 4. When the user clicks the training program start object 400, the question card 30 may be activated after loading for a predetermined time according to the user's wired/wireless network environment. During the loading, a loading screen 20 may be displayed.

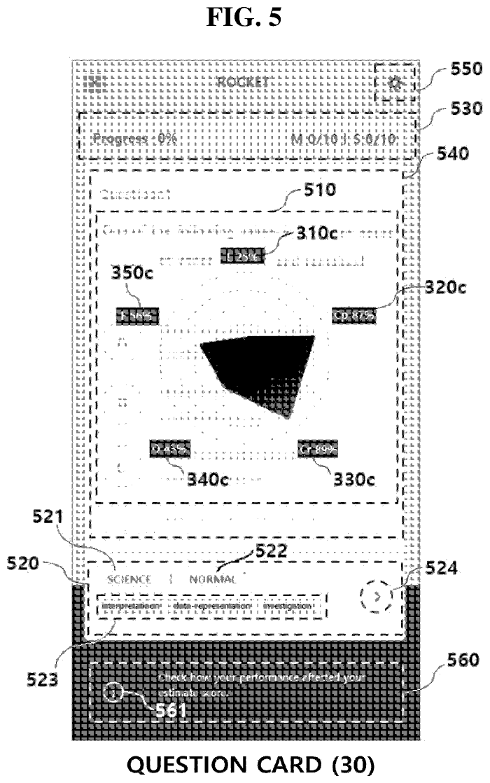

Referring to FIG. 5, The question card 30 may include a radar chart (see 300 in FIG. 2) including a plurality of prediction values in a first area 510, summary information 521 and 522 on the recommended question in a second area 520, a training status display window in a third area 530, and a question preview image in a fourth area 540. In addition, the question card 30 may include a customization configuration object (see 200 in FIG. 2) that can execute a customization configuration window that can configure question recommendation conditions according to the user's selection in a fifth area 550, and a prediction status display window in a sixth area 560.

The recommended question may be determined in consideration of the user's training ability analyzed through the AI model. A training element to be considered may include one or more of the prediction values for each question displayed on the question card 30. The AI model may determine the recommended question by using prediction values of one or more of the predicted acquisition score 310c, the solving completion probability 320c, the correct answer probability 330c, the on-time probability 340c, and the difference 350c.

For example, 1) based on only the correct answer probability 330c, questions having a correct answer probability smaller than a configuration value may be determined as the recommended questions, 2) based on the correct answer probability 330c and the solving completion probability 320c, questions in which the solving completion probability 320c is larger than a second configuration value among questions in which the correct answer probability 330c is less than a first configuration value may be determined as the recommended questions, and 3) in consideration of all prediction values, firstly, after comparing an average value of five prediction values with a third configuration value, secondly questions in which the correct answer probability 330c is less than a fourth configuration value may be determined as the recommended questions.

Various methods may be used to determine the recommended question using the prediction value, and the recommended question may be determined through prediction data of various AI models in addition to the above-mentioned five prediction values.

The activated question card 30 may display an AI prediction score reflecting user's individual training ability. Through the question card 30, the user may check the predicted acquisition score 310c when the user gets the question corresponding to the question card 30 correct, the solving completion probability 320c which is a probability of completing the solving without dropping out of the training program during solving the corresponding question, the correct answer probability 330c in which the user gets the corresponding question correct, the on-time probability 340c in which the user completes the corresponding question solving within a given time, and the difference 350c that quantitatively expresses the difference between the corresponding question and the question previously solved by the user.

The AI tutor may provide the user with one recommended question and the question card 30 for the recommended question at a time. There were frequent cases of simply scanning a physical test sheet printed on paper or transferring the configuration of the test sheet to a mobile environment as it is. There was a problem that it was difficult to the user to concentrate for a long time because the user had to read and solve a plurality of questions and text on a small screen, and that the user easily terminates and drops out of the training program.

The device and method for providing training content according to an embodiment of the present disclosure may provide one recommended question for solving one question on a well-arranged user interface and analyzed information of the recommended question may be provided through the question card, thereby increasing the user's concentration and reducing a dropout rate.

Furthermore, the question card may help the user in choosing whether to solve the corresponding question by displaying summary information about the question itself.

Referring to FIG. 5, the question card 30 may include a question preview image in the fourth area 540. In addition, the fifth area 550 may include the customization configuration object 200 capable of executing a customization configuration window for configuring a question recommendation condition according to a user's selection.

The training status display window may include one or more of progress, the number of questions that the user gets correct, the number of questions that the user gets incorrect, the number of solved questions, and the number of skipped questions. Through training status display window of the third area 530, the user can intuitively check in real time to what extent he or she has progressed in the entire training process.

The training status display window of the third area 530 may further include the recommended number of questions to be solved within a specific time recommended by the AI model. The specific time may be variously defined according to an embodiment, such as an average training time of the user, a day, a week, or a month. The user may have a target training amount through the recommended number of questions. When the user learns with a specific target amount of training than when solving questions in an abstract way, he or she can solve more questions with more concentration.

The recommended number of questions may be calculated according to various algorithms. For example, a method which the initial recommended number of questions is determined in consideration of the user's average question-solving speed and the recommended number of questions is gradually increased, the user's question-solving speed may be determined to be improved. In addition, the recommended number of questions may be determined according to the difficulty of the questions. When a large number of questions with high difficulty are included, the recommended number of questions may decrease, and when a large number of questions with low difficulty are included, the recommended number of questions may increase. In addition, the recommended number of questions may be determined by synthesizing various training data of users.

The question preview image of the fourth area 540 may display a portion of the question object, and the user can schematically check the question to be solved through the question preview image. The question preview image may overlap the radar chart and may be display as a translucent image. The portion of the question object displayed by the question preview image may be the upper portion of the question object. For example, only the question may be displayed and the choices may be truncated, or only the portion of the question and choices may be displayed.

However, according to an embodiment, the question preview image may be displayed in a way in which key content determined to be important is extracted from the question object. The key content may include keywords of the question object, key sentences, words, phrases, sentences, etc., indicating the subject of the passage. The key content may be extracted by an expert in advance and stored as tagged in the question object.

When the user wants to solve the recommended question, the user may perform a predetermined operation such as clicking on an arbitrary area of the question card 30, dragging the screen in a predetermined direction, or double-clicking on the screen. At this time, the question preview image may be converted from a translucent state image to a clear image. On the contrary, the radar chart may gradually increase in transparency and eventually disappear from the screen, and only the question object can be displayed on the screen.

However, the transition of the question card 30 and the question preview image through the brightness change is an example, and the question card 30 and the question preview image may be switched by various techniques such as flying from one side of the screen, displayed while being rotated, bounded, or displayed or disappear with a wipe effect.

The subject information 521 may be information showing which subjects the corresponding question corresponds to, such as math, science, English, Korean, social studies, and history. In the question difficulty information 522, in view of the average user's training level, a question with a relatively low correct answer probability may be displayed as a difficult question (Hard), a question with an average correct answer probability may be displayed as a normal difficulty question (Normal), and a question with a high correct answer probability may be displayed as an easy question (Easy).

The fifth area 550 of the question card 30 may include the customization configuration object 200 that can configure the question recommendation condition including one or more of receiving recommendation only for a question for a specific subject, receiving recommendation only for a question with a specific tag, and receiving a recommendation only for a question of a specific difficulty. When the user clicks the customization configuration object, the customization configuration window for configuring the question recommendation condition may be activated.

The tag information 523 for the question type may be information that can roughly identify the subject or type of the corresponding question, which includes words that are key to the subject or solution of the corresponding question such as grammar, vocabulary, listening, reading, speaking, etc., a format of text such as words, emails, articles, letters, official documents, and key concepts of the corresponding question including infinitives, articles, gerunds, or tenses.

The user may check information about the corresponding recommended question through the question card 30 and may determine whether to solve the question. If the user does not want to solve the question, the current recommended question may be skipped through a predetermined operation, such as swiping, and the user may move on to the next recommended question.

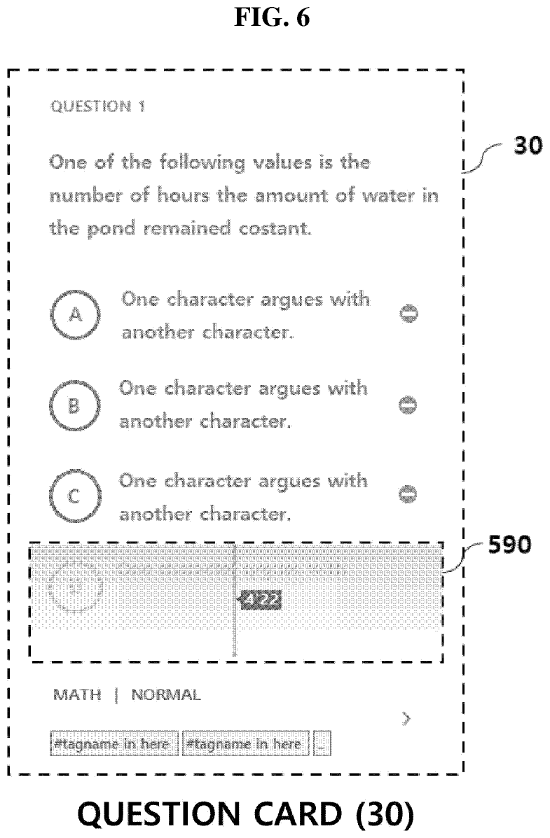

The sixth area 560 of the question card 30 may include a prediction status display window. The user may check the prediction status data for the current training through the prediction status display window. The prediction status data may be directly displayed in the sixth area 560, or a separate prediction status display window may be displayed as a pop-up window when the window is clicked by the user. According to an embodiment, the prediction status display window may be a gradation display window 590 of FIG. 6.

The prediction status data may include one or more of a predicted score predicted based on questions solved so far, a trend of the predicted score, and the number of additional questions to be solved until the predicted score is updated.

Whenever the user solves a question, the prediction status data may be updated in real time by reflecting the question-solving result. The method and device for providing training content according to an embodiment of the present disclosure may newly calculate the predicted score for each question-solving and may display a predicted score trend by synthesizing the previous predicted score history. The predicted score trend may be displayed using various types of graphs or tables.

However, according to an embodiment, in order to predict the corresponding score, it may require two or more question-solving results sufficient to predict the corresponding score rather than one question. The prediction status display window may display the number of additional questions to be solved until the predicted score is updated on the prediction status display window.

The user may check the number of solved questions through a counter window 561. In the counter window 561, the number of questions solved by the user for each chapter may be displayed, and the number of questions solved by the user throughout the entire chapter may be displayed. The number of solved questions displayed in counter window 561 may be initialized every time the predicted score is calculated, and when the predicted score is initialized, it may be counted from 0 again. The user may continue to solve the questions to increase the predicted score through the counter window 561, and more question solving may be induced through the above-described process.

FIG. 6 is a diagram illustrating a gradation display window 590 of a question card according to an embodiment of the present disclosure.

Referring to FIG. 6, the gradation display window 590 may be activated by clicking a view more object 524 for further viewing question information or on the screen of FIG. 5 in which the question card 30 is displayed, or may be activated by an operation of dragging from lower part to the upper part of the screen.

The gradation display window 590 may display additional information about a recommended question that cannot be confirmed only with the subject information 521, the question difficulty 522, and the tag information 523 for the question type displayed at the bottom of FIG. 5.

For example, when a learner solves a recommended question in the future, a tip that the learner can refer to, an average correct answer probability of other users, the frequency of questions asked, and an expert's explanation on the reason why the corresponding question is determined as the recommended question may be included. All of this additional information may be stored in the storage unit 150 and may be popped up according to a user's selection.

The user may fix any one or more of this additional information through configuration at the bottom of the question card 30 in which the subject information 521, the question difficulty 522, and the tag information 523 on the question type are displayed. Conversely, one or more of the subject information 521, the question difficulty 522, and the tag information 523 on the question type may be moved to the gradation display window 590.

In addition, as described above in the description of FIG. 5, the gradation display window 590 may include the prediction status display window. The user may check one or more of the predicted score, the predicted score trend, and the number of questions to be additionally solved until the predicted score is updated through the gradation display window 590.

In this way, the user may configure conditions for determining the recommended question and may change the configuration itself of the question card 30 according to his or her taste. Various combinations of the question cards may be possible by the number of users of the training program, and the configuration of the question card can be shared among user, and each user can reconfigure the question card with a configuration that ca accurately reflect their preference.

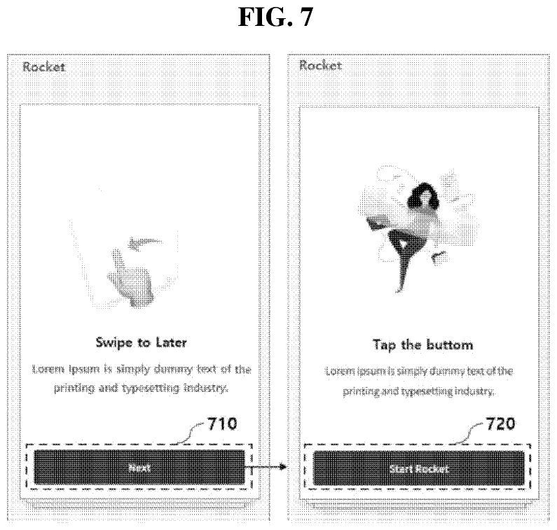

FIG. 7 is a diagram illustrating a swipe guide message according to an embodiment of the present disclosure.

Referring to FIG. 7, when the training program is executed, a swipe guide message 710 of FIG. 7 may be activated before the intro screen 10 of FIG. 2 is activated. The swipe guide message 710 may configured to be activated only once when the user initially executes the training program, or configured to be activated only up to a specific point in time according to the user's configuration.

When the swipe guide message 710 is checked and clicked, an execution button 720 capable of moving to the intro screen 10 may be activated. When the execution button 720 is clicked, the user interface environment for performing training may be activated by switching to the intro screen 10.

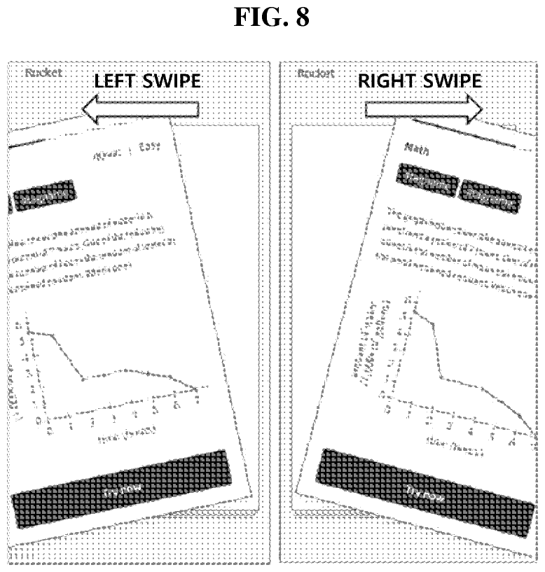

FIG. 8 is a diagram illustrating a swipe operation according to an embodiment of the present disclosure.

Referring to FIG. 8, a user may be provided with a recommended question from the AI tutor, and when the user does not like the recommended question, the user may swipe the screen in a specific direction to skip the currently displayed question and move on to the next question. The swipe operation may be described as an operation of continuously dragging from one area of the screen to another area over a predetermined distance.

In an embodiment, left swipe and right swipe have been described separately, but both can perform the same function of skipping the current question and moving on to the next question.

In another embodiment, the left (or right) swipe is an instruction to skip the current question and move on to the next problem, and the right (or left) swipe is an instruction to go to the question-solving screen in order to solve the current question.

In still another embodiment, the swipe operation may be configured to perform various instructions (expected operations) depending on the direction. For example, the right swipe may be configured as a “question the user doesn't want to see again”, and the left swipe may be configured as a “question the user wants to see again after a predetermined time”. The expected operation may be set differently depending on the swipe operation in any direction by 360 degrees as well as left and right, and the expected operation may also include various methods of calling or skipping a question.

FIG. 9 is a diagram illustrating a customization configuration according to an embodiment of the present disclosure.

Referring to FIG. 9, the user may activate the customization configuration window by clicking the customization configuration object 200 on the intro screen.

The user may select a criterion for determining a recommended question through the customization configuration window. For example, it is possible to configure various user-customized question recommendation conditions, including receiving a recommendation only for a question for a specific subject, receiving a recommendation only for a question with a specific tag, and receiving a recommendation only for a question with specific difficulty.

Although it is illustrated in FIG. 9 that each of the four configuration areas 210, 220, 230, and 240 can be configured through the customization configuration window, more or fewer search conditions may be included according to an embodiment. The search condition may be pre-applied in a “Insert here” field, and the user may activate or deactivate the search condition through activation buttons 211, 221, 231, and 241 located on the right side of each configuration area 210, 220, 230, or 240.

Although the activation buttons 211, 221, 231, and 241 are displayed in the form of radio buttons for activating or deactivating by moving a circular circle to the left or right in FIG. 9, according to an embodiment, the activation buttons 211, 221, 231, and 241 may be implemented as a slide button or a dial button for configuring the search condition to a specific range, or may be implemented as a method in which the user directly inputs the condition of the recommended question.

FIG. 5 shows that the customization configuration object 200 is located in the upper right corner of the intro screen 10, but according to an embodiment, the customization configuration object 200 may be also displayed in the upper right corner of the question card 30 or a specific area of the question object. The user may change the criteria of the recommended question by activating the customization configuration window at any time during training.

The user may determine their preferred question type in advance through the customization configuration window, and whenever a question they do not want to solve comes up, it can be prevented from moving on to the next question or even ending the training program itself. As a result, by increasing the training time, the user can be encouraged to solve more questions.

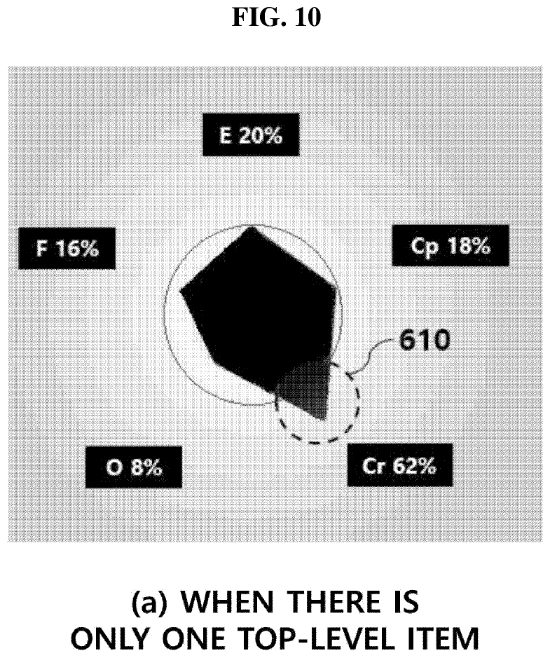

FIG. 10 is a diagram illustrating a radar chart (see 300 of FIG. 2) in the case where there is one item having the highest value according to an embodiment of the present disclosure.

A plurality of prediction values may be displayed through the radar chart 300, and the color of a specific area of the radar chart 300 may be changed and displayed according to the number of prediction values having the highest values among the plurality of prediction values.

Referring to FIG. 10, it is shown that the predicted acquisition score (E), the solving completion probability (Cp), the correct answer probability (Cr), the on-time probability (O) and the difference (F) according to the AI calculation result are displayed on the radar chart 300.

When a specific prediction value is higher than other prediction values, an edge representing the corresponding prediction value may be highlighted in a different color to distinguish it from other prediction values and then displayed. FIG. 10 shows that the edge of the correct answer probability (Cr), which is the highest prediction value, may be displayed and highlighted in a brighter color than the edges of other prediction values.

In an embodiment, the predicted acquisition score (E) is 20%, the solving completion probability (Cp) is 18%, the correct answer probability (Cr) is 62%, the on-time probability (O) is 8%, and the difference (F) is 16%. Among them, the highest prediction value is the correct answer probability (Cr), which has a value of 62%. Accordingly, the correct answer probability (Cr) may be highlighted in a brighter color, unlike the other four prediction values, and then displayed.

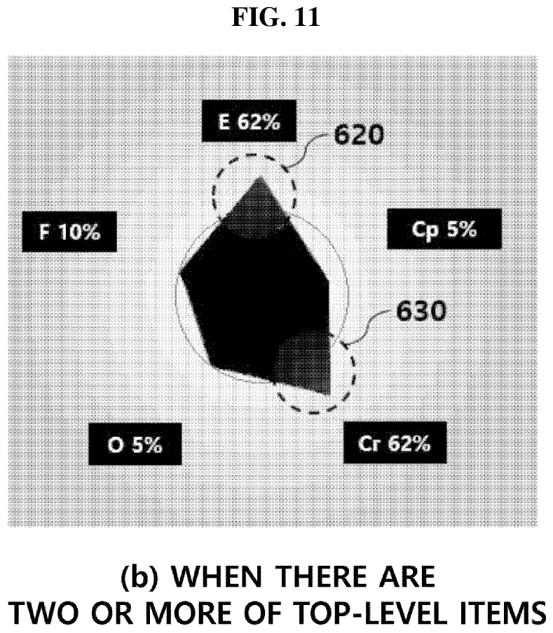

FIG. 11 is a diagram illustrating the radar chart 300 when there are two or more items having the highest value according to an embodiment of the present disclosure.

Referring to FIG. 11, it is shown that the predicted acquisition score (E), the solving completion probability (Cp), the correct answer probability (Cr), the on-time probability (O) and the difference (F) according to the AI calculation result are displayed on the radar chart 300.

When there are two or more items having the highest value, edges representing these prediction values may be highlighted in a different color to distinguish them from edges representing other prediction values and then displayed. In FIG. 11, each edge representing the predicted acquisition score (E) and the correct answer probability (Cr), which are the highest prediction values, may be displayed and highlighted in a brighter color than the other prediction values.

In an embodiment, the predicted acquisition score (E) is 62%, the solving completion probability (Cp) is 5%, the correct answer probability (Cr) is 62%, the on-time probability (O) is 5%, and the difference (F) is 10%. Among them, the highest prediction value is the predicted acquisition score (E) and the correct answer probability (Cr), which have a value of 62%. Accordingly, the predicted acquisition score (E) and the correct answer probability (Cr) may be highlighted in a brighter color, unlike the other three prediction values, and displayed.

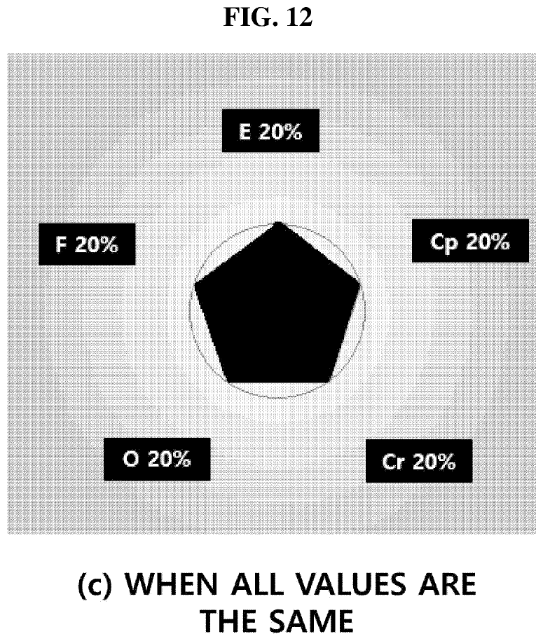

FIG. 12 is a diagram illustrating the radar chart 300 in the case where values of all items are the same according to an embodiment of the present disclosure.

Referring to FIG. 12, it is shown that the predicted acquisition score (E), the solving completion probability (Cp), the correct answer probability (Cr), the on-time probability (O) and the difference (F) according to the AI calculation result are displayed on the radar chart.

Unlike FIGS. 10 and 11, it can be confirmed that any one of the prediction values is not higher than the other prediction values. In this case, the edges representing all prediction values may be expressed in the same color, and there may not be a separately emphasized prediction value.

In an embodiment, the predicted acquisition score (E), the solving completion probability (Cp), the correct answer probability (Cr), the on-time probability (O), and the difference (F) all have a value of 20%. Since all five prediction values have the same value, they can all have the same color edge.

The user may overlook the reason why the recommended question is determined or the necessity of solving the recommended question through the radar chart 300 simply displayed in the same color. When a color is differently applied to the prediction value of the radar chart 300 according to importance, the user can check the intuitively emphasized prediction value and may reconsider the training necessity of the recommended question. In addition, in the aesthetic part, by configuring the radar chart 300 in various colors, there is an effect of allowing users who value design to be more interested and easily accessible.

In FIGS. 10 to 12, an example of emphasizing by changing the color of the edge of the radar chart 300 has been described, but according to embodiments, the prediction values may be emphasized through various methods.

The embodiments of the present disclosure disclosed in the present specification and drawings are merely provided for specific examples to easily explain the technical content of the present disclosure and help the understanding of the present disclosure, and are not intended to limit the scope of the present disclosure. It will be apparent to those of ordinary skill in the art to which the present disclosure pertains that other modifications based on the technical spirit of the present disclosure can be implemented in addition to the embodiments disclosed herein.

### INDUSTRIAL APPLICABILITY

The method of providing training content as described above can be applied to the field of online education services.

1. A method for providing training content in a learner terminal, the method comprising:
displaying, on a first area of a screen, a recommended question determined using an artificial intelligence (AI) model trained on the basis of training data of a user and a plurality of prediction values obtained by predicting a training result of the user for the recommended question;
displaying summary information about the recommended question in a second area of the screen; and
displaying a question object of the recommended question on the screen of the learner terminal when the user decides to solve the recommended question on the basis of the plurality of prediction values and the summary information,
wherein the prediction value includes a solving completion probability which is a probability of solving the recommended question to the end without terminating a training program after the user starts to solve the recommended question.

2. The method of claim 1, further comprising:
displaying, in a third area of the screen, a training status display window including one or more of progress, the number of questions that the user gets correct, the number of questions that the user gets incorrect, the number of solved questions, the number of skipped questions, and the recommended number of questions to be solved within a specific time.

3. The method of claim 1, wherein the second area includes a view more object for further viewing question information to determine additional information about the recommended question in addition to the summary information,
the method further comprising:
displaying the additional information when the user clicks the view more object.

4. The method of claim 1, further comprising:
displaying a swipe guidance message indicating that the user can skip the recommended question that the user does not want to solve through a swipe operation before the displaying of the plurality of prediction values and the recommended question,
wherein the swipe guidance message is configured to be activated only once when the user initially executes the training program, or to be activated only up to a specific time point according to a user's configuration.

5. The method of claim 1, wherein the plurality of prediction values includes one or more of a predicted acquisition score, a solving completion probability, a correct answer probability, an on-time probability, and a difference, and the summary information includes one or more of subject information, question difficulty, and tag information about a question type.

6. The method of claim 5, wherein the displaying of the plurality of prediction values and the recommended question comprises:
displaying the plurality of prediction values through a radar chart, and changing and displaying a color of a specific area of the radar chart according to the number of the highest prediction values among the plurality of prediction values.

7. The method of claim 1, further comprising:
displaying a portion of a question object of the recommended question in which a question to be solved by the user can be checked, in a fourth area of the screen.

8. The method of claim 1, wherein a fifth area of the screen further includes a customization configuration object that can configure a question recommendation condition including one or more of receiving a recommendation only for a question for a specific subject, receiving a recommendation only for a question with a specific tag, or receiving a recommendation only for a question with a specific difficulty,
the method further comprising:
activating a customization configuration window that can configure the question recommendation condition when the user clicks the customization configuration object.

9. A device for providing training content, the device comprising:
a storage unit configured to store training content and training data of users;
a UI generation unit configured to generate a user interface for displaying a recommended question determined using an AI model trained on the basis of the training data and a plurality of prediction values obtained by predicting training ability of the user for the recommended question; and
a communication unit configured to transmit the training content and the plurality of prediction values displayed according to the user interface to a learner terminal,
wherein
the plurality of prediction values and the recommended question are displayed on a first area of a screen of the learner terminal, summary information about the recommended question is displayed on a second area of the screen, and a question object of the recommended question is displayed on the screen of the learner terminal when the user decides to solve the recommended question on the basis of the plurality of prediction values and the summary information, and
the prediction values include a solving completion probability which is a probability of solving the recommended question to the end without terminating a training program after the user starts to solve the recommended question.
